(19) United States
(12) Patent Application Publication
(10) Pub. No.: US 2002/0072998 A1
(43) Pub. Date: Jun. 13, 2002

(54) Consumable order-assistance system for computer peripheral devices within a centralized network environment and method for replenishing consumable components

(76) Inventors: Robert E. Haines, Boise, ID (US); Mark A. Harper, Middleton, ID (US); Kenley Hinrichs, Meridian, ID (US); Mary B. Baumunk, Boise, ID (US); Jodi Goettemoeller, Boise, ID (US); Sharon Whaley, Meridian, ID (US)

Correspondence Address: HEWLETT-PACKARD COMPANY, Intellectual Property Administration, P.O. Box 272400, Fort Collins, CO, 80527-2400, US

(21) Appl. No.: 09/733,472

(22) Filed: Dec. 8, 2000

(51) Int. Cl. G06F 17/60

(52) U.S. Cl. 705/28

(57) ABSTRACT

A consumable component replenishment and maintenance assistance system is provided within a centralized network environment. The system includes a computer network, at least one computer peripheral device, a personal computer, and a centralized server. The at least one computer peripheral device is provided within the network and has an embedded web server and a consumable component. The personal computer is provided within the network and has a user interface usable by a maintainer to maintain operation of the at least one computer peripheral device. The server is provided within the network and has a consumable component consolidation program. The program is operative to monitor the at least one computer peripheral device to identify a need to replenish a consumable component and/or perform maintenance, consolidate the identified need to replenish the consumable component or perform maintenance for one or more of the at least one computer peripheral device in the network environment, and notify a maintainer of the consolidated, identified need by rendering instructions that are sent to the maintainer at the personal computer. A method is also provided.

### COPYRIGHT NOTICE

Contained herein is material, including material incorporated by reference, which is subject to copyright protection. The copyright owner does not object to the electronic, facsimile, or electrophotographic reproduction of the patent disclosure by any person as it appears in the Patent and Trademark Office patent files or records, but otherwise reserves all rights to the copyright whatsoever.

### FIELD OF THE INVENTION

This invention pertains to computers and computer peripheral devices that utilize consumables within a centralized system. More particularly, this invention relates to the rendering of assistance when ordering consumables to replenish consumables and/or perform needed maintenance on one or more computer peripheral devices present within a centralized network environment.

### BACKGROUND OF THE INVENTION

As computer systems have gained widespread use, particularly within centralized network environments, the use of computer peripheral devices has increased significantly. Likewise, the utilization of consumables for such computer peripheral devices has also increased significantly. One problem often encountered with any computer system results because consumables are manually ordered by a user, a maintainer, a consumables purchaser or a system administrator. The consumables are typically ordered when they run out, or when the computer peripheral device or associated personal computer notifies a user, maintainer, consumables purchaser, or system administrator that the consumables have been or are about to be depleted.

One such environment comprises a centralized network environment, such as for an office or business, including one or more personal computers (PCs), one or more computer peripheral devices, a network that connects together the PCs and peripheral devices, and a server. Such an environment has been referred to as a computer network environment, and may include an intranet or a connection to an external network such as the Internet.

The ordering of consumables for computer peripheral devices within small and medium office network environments has been a manual process. For example, consumables are manually ordered by a network user, maintainer or administrator within the network environment for photo copiers, facsimile machines, printers and multiple function peripheral devices that include more than one of these functional devices. Due to the wide adoption of such devices within such centralized network environments, a need exists to be able to more easily and accurately order consumables and supplies to replenish depleted consumables. For example, a need exists to assist in ordering of paper, toner, toner supply cartridges, ink, and ink reservoirs.

The ability to enhance ordering of consumables within a centralized network environment would greatly increase efficiency in ordering multiple, unique consumables and ordering consumables for multiple, unique peripheral devices within a common network. A similar efficiency is realized when servicing parts or performing maintenance. A user tasked with ordering such consumables will save time and effort by enhancing the way in which consumables are identified and ordered which will minimize the time and effort needed to maintain consumables and keep computer peripheral components functional. Accordingly, it is desirable to enhance the ease and speed with which consumables are replenished and/or replaced so that adequate supplies of consumables are available for one or more computer peripheral devices when such consumables are sufficiently depleted so as to warrant replenishment.

### SUMMARY OF THE INVENTION

A system and method are provided for assisting a user in detecting a need to replenish a consumable and to service a peripheral device. Additionally, the system and method can assist and/or automatically order such consumable for purposes of replenishing the consumable.

According to one aspect, a consumable component replenishment and maintenance assistance system is provided within a centralized network environment. The system includes a computer network, at least one computer peripheral device, a personal computer, and a centralized server. The personal computer is provided within the network and has a user interface usable by a maintainer to maintain operation of the at least one computer peripheral device. The server is provided within the network and has a consumable component consolidation program. The program is operative to monitor the at least one computer peripheral device to identify a need to replenish a consumable component and/or perform maintenance, consolidate the identified need to replenish the consumable component and/or perform maintenance for one or more of the at least one computer peripheral device in the network environment, and notify a maintainer or a purchaser of the consolidated, identified need by rendering instructions that are sent to the maintainer at the personal computer.

According to another aspect, a consumable order assistance system is provided for a computer peripheral device within a centralized network environment. The system includes a personal computer, a computer peripheral device, a centralized server, a computer network, and an electronic communication link. The personal computer has a user interface. The centralized server has a consumable re-order program including instructions to send a consumable re-order notification to a consumables purchaser at the personal computer. The computer network interconnects the personal computer, the computer peripheral device, and the centralized server. An electronic communication link signal couples the personal computer with a provider of the consumable for the peripheral device. The electronic communication link is operative to send the re-order notification to the provider.

According to yet another aspect, a computer-implemented system is provided which implements a program in which consumable components of computer peripheral devices in a centralized network system are replenished. The system includes a monitoring system, a notification system, and a consumable order placement system. The monitoring system identifies a need to replenish one or more consumable components and/or perform maintenance for any one of a plurality of unique computer peripheral devices within the network system. The notification system notifies a user of the identified need to replenish components and/or perform maintenance. The consumable order placement system generates an order with a supplier of consumables in response to a user authorizing the order.

According to even another aspect, a method is provided for replenishing consumable components of at least one computer peripheral device within a centralized network. The method includes: providing a centralized server within the network communicating with the at least one computer peripheral device; detecting a need to replenish a consumable component and/or perform maintenance for each of the at least one computer peripheral component; consolidating the identified need to replenish the consumable component and/or perform maintenance for one or more of the at least one computer peripheral device in the network; and notifying a network user of the consolidated, identified need by rendering and forwarding instructions to the network user.

Other features and advantages of the invention will become apparent to those of ordinary skill in the art upon review of the following detailed description, claims, and drawings.

### DESCRIPTION OF THE DRAWINGS

Preferred embodiments of the invention are described below with reference to the following accompanying drawings depicting examples embodying the best mode for practicing the invention.

FIG. 1 is simplified block diagram of a consumable component replenishment and maintenance assistance system for a centralized network environment provided by one or more personal computers (PCs) and one or more computer peripheral devices that are coupled together within a network, and wherein a communication link with an external network is further provided such as the Internet, in accordance with one embodiment of the present invention.

FIG. 2 is simplified block diagram of the peripheral management system of FIG. 1.

FIG. 3 is a flow diagram of an office network having a plurality of personal computers (PCs), and a plurality of printers which are directly connected together through the network to provide a network connection environment, and illustrating interactions by maintainers, end users, and one or more purchasers that lead to manual ordering of toner when replenishing toner.

FIG. 4 is a flow diagram of an office network having a plurality of personal computers (PCs), and a plurality of printers which are directly connected together through the network to provide a network connection environment, and illustrating interactions with maintainers, end users, and one or more purchasers that lead to consolidated and automated ordering of multiple consumables such as toner and supplies when replenishing a consumable.

FIG. 5 is a sequence diagram of setup interactions between individuals and devices in FIG. 4.

FIG. 6 is a sequence diagram illustrating interactions when polling Legacy devices.

FIG. 7 is a sequence diagram illustrating interactions when generating a toner low alert from an embedded web server (EWS)-based device.

FIG. 8 is a sequence diagram illustrating interactions when sending an email maintenance alert to a maintainer via an AutoReorder System and a device that has generated a toner low alert.

FIG. 9 is a sequence diagram illustrating ordering interactions between individuals and devices of FIG. 4.

FIG. 10 is a simplified flowchart illustrating a process for replenishing consumables for one or more computer peripheral devices within a centralized network environment such as an office environment as shown in FIGS. 1, 2 and 4 in accordance with embodiments of the present invention.

### DETAILED DESCRIPTION OF THE INVENTION

This disclosure of the invention is submitted in furtherance of the constitutional purposes of the U.S. Patent Laws “to promote the progress of science and useful arts”. U.S. Constitution, Article 1, Section 8.

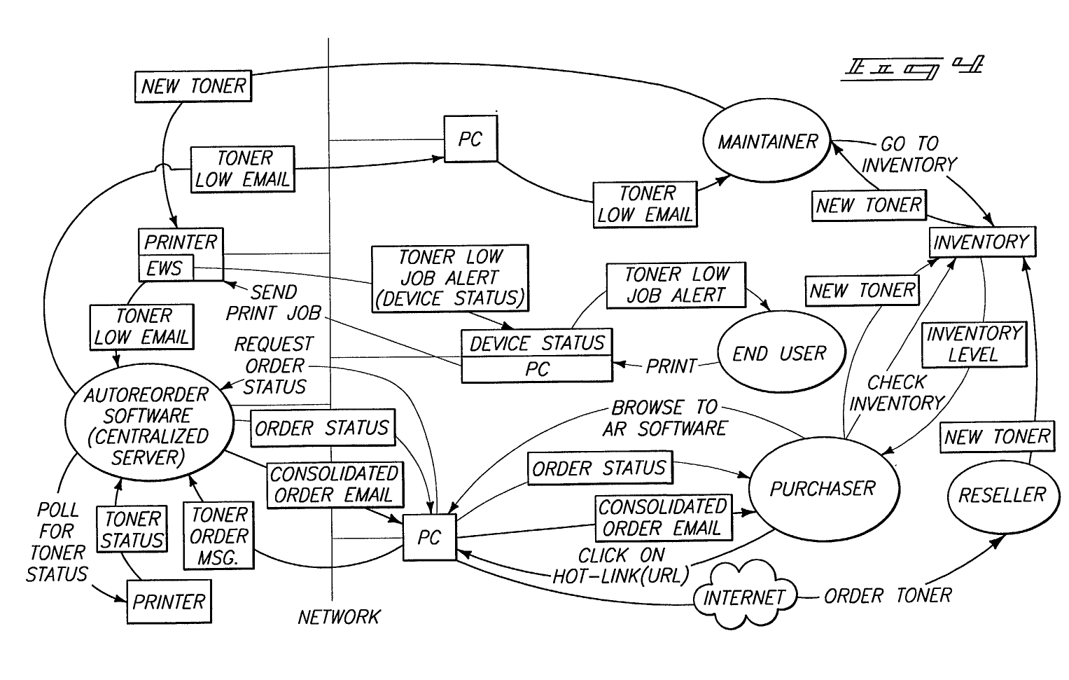

Reference will now be made to a preferred embodiment of Applicant's invention. One exemplary implementation within an office network environment is described below and depicted with reference to FIGS. 1, 2, and 4. Another exemplary implementation within an office network environment is described below and depicted with reference to FIG. 1. An office environment provides one example. However, it is understood that implementation can occur with any environment composed of multiple printers and PCs that are connected in such a way so that a centralized server can communicate with all of the printers, and send messages to the PCs. It may be possible to implement the system within a home environment, where the home environment is networked. Details of the problem encountered with prior art techniques for offices are described below with reference to the state diagram of FIG. 3. While the invention is described by way of a preferred embodiment, it is understood that the description is not intended to limit the invention to these embodiments, but is intended to cover alternatives, equivalents, and modifications such as are included within the scope of the appended claims.

In an effort to prevent obscuring the invention at hand, only details germane to implementing the invention will be described in great detail, with presently understood peripheral details being incorporated by reference, as needed, as being presently understood in the art.

FIG. 1 is a simplified block diagram of a computer network environment 10 including a plurality of personal computers (PCs) 12, 12′ and a plurality of dedicated computer peripheral devices 14, 14′. Each computer peripheral device 14, 14′ is signal coupled with each PC 12, 12′ via a network 16. A consumable component replenishment and maintenance assistance system identified by reference numeral 18, in accordance with two embodiments of the present invention, is provided within network 16. Network environment 10 provides a centralized network connection between PCs 12, 12′ and peripheral devices 14, 14′. According to one construction, computer peripheral device 14 comprises a printer 20, such as a laser printer or an ink jet printer, or any other form of hard copy output device including a copier, a mopier, or a multiple-function peripheral device (MFP).

PC 12′ includes a central processing unit (CPU) 22, memory 24, a device status utility 26, a device driver 28, and a user interface 27 having a display 29. PC 12 is identical to PC 12′, except that PC 12 has an email interface 25. It is understood that either of PCs 12 and 12′ could have all of the above components. As described herein, a purchaser interacts with the system via email, whereas an end user interacts with the system via device status and a device (or printer) driver. It is understood that email provides merely one technique for communicating, and that device status provides another technique. However, the invention should not be limited to any one specific technique of communication. CPU 22 comprises processing circuitry. It is understood that PCs 12 and 12′ each comprise a network computer utilized within a network environment.

Computer peripheral device 14 includes a print, or printer, engine 30. Print engine 30 enables peripheral device 14 to initiate data communication over network 16 with any one of PCs 12 and 12′. Likewise, device driver 28 enables PC 12′ to initiate data communication with any one of peripheral devices 14 and 14′ over network 16.

According to one embodiment, device driver 28 of PC 12′ comprises a printer driver. Additionally or optionally, computer peripheral device 14 comprises a hard copy device such as a copier, a mopier, a facsimile machine, or a multiple function peripheral (MFP) device capable of providing two or more of such functions. Furthermore, it is understood that personal computers 12 and 12′ can each include a device driver.

According to one embodiment, PC 12 is signal coupled to an external network 32 comprising the Internet 34 via a data path 36 that includes Internet access. In one case, PC 12 communicates via the Internet 34 to order consumable supplies from a vendor, or resupplier, 35. In one embodiment, data path 36 also includes a secure data path using HTTP (hyper text transfer protocol ) with SSL (secure sockets layer), as described in more detail in U.S. Pat. No. 5,657,390, entitled “Secure Socket Layer Application Program Apparatus And Method”, issued to Elgamal et al., and U.S. Pat. No. 6,081,900, entitled Secure Intranet Access”, issued to Subramanian et al., wherein such patents are hereby incorporated herein by reference.

Computer peripheral device 14 comprises a printer 20 having a formatter 38, including memory 40. An embedded web server (EWS) 42 is stored within memory 40. EWS 42 comprises a web server in the form of an embedded software module that serves up HTTP (HyperText Transport Protocol) content and other Internet-related content at computer peripheral device 14. Formatter 38 further includes a central processing unit (CPU) 39 and an input/output (I/O) interface 41. Furthermore, printer 20 includes display and user interface 44, 46 as well as a print engine 30. Computer peripheral device 14′ is a Legacy computer peripheral device (or a device that lacks an EWS 42) comprising a printer 120 having a formatter 138. Formatter 138 includes a CPU 39, memory 40, and an I/O interface 41. Printer 120 further includes a display and user interface 44, 46, as well as a print engine 30.

According to one construction, print or printer engine 30 comprises a controller, such as a conventional microprocessor or microcontroller, with a memory 40 communicating with the controller. In one embodiment, memory 40 comprises non-volatile memory such as a read only memory (ROM) and volatile memory such as random access memory (RAM).

According to one implementation, network 16 comprises a client/server architecture, wherein personal computers 12 and 12′ each comprise a personal computer within a network, otherwise referred to as a workstation. Furthermore, a server 48 is provided within network 16. Furthermore, a plurality of printers 20 are interconnected with each client and server via network 16.

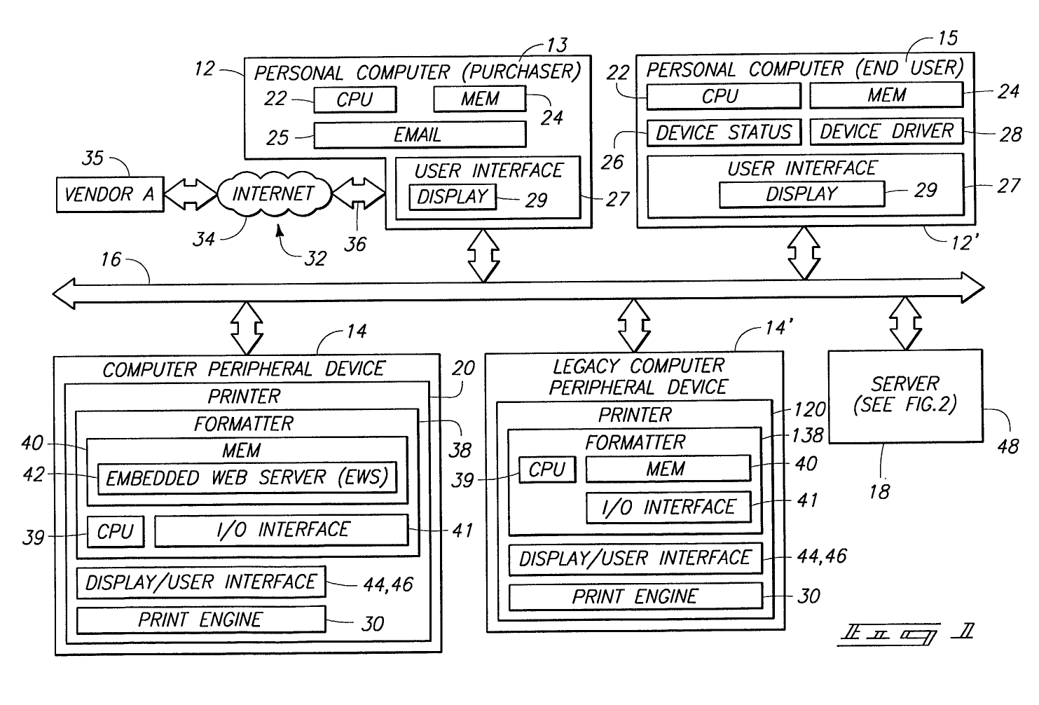

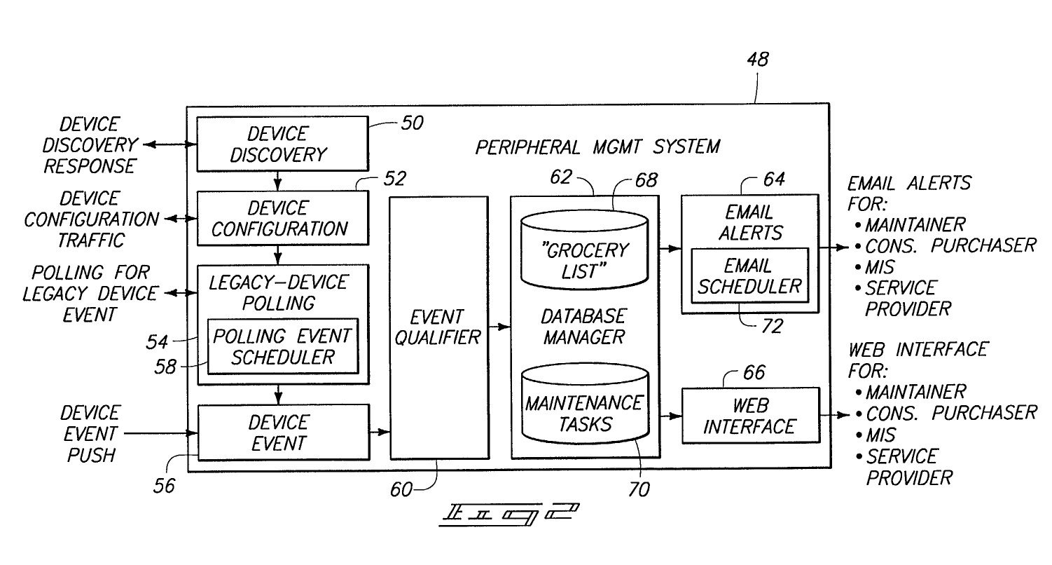

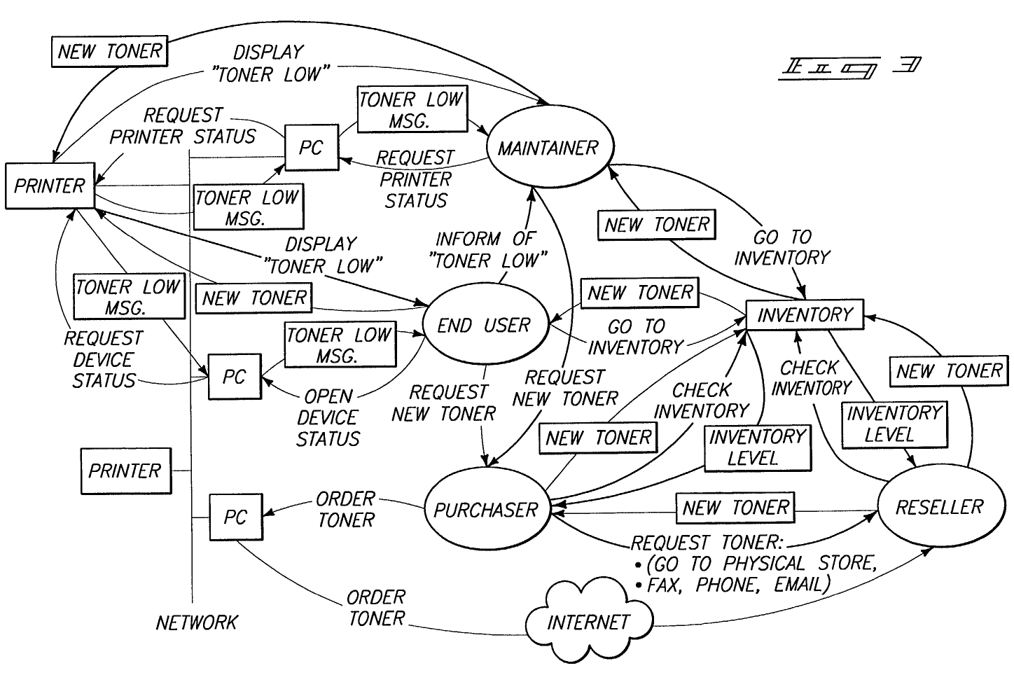

Server 48 comprises a centralized server within network 16. Server 48 comprises a peripheral management system 52. Further details of server 48 are provided below with reference to FIG. 2.

FIG. 2 illustrates details of peripheral management system 48, as implemented on a server. More particularly, system 48 contains processing circuitry configured to implement device discovery 50, device configuration 52, legacy-device polling 54, device event receive 56, event qualifier 60, a database manager 62, email alerts 64, and a web interface 66. Legacy-device polling 54 comprises a polling event scheduler 58. Database manager 62 comprises a “grocery list” 68 of consumables needing replacement and/or maintenance items. Database manager 62 also comprises a list of maintenance tasks 70. “Grocery list” 68 and maintenance tasks 70 are stored in memory of database manager 62. Furthermore, email alerts 64 comprise an email scheduler 72.

Device discovery 50 participates in discovering computer peripheral devices within the network. A device discovery response is generated by device discovery 50 when a device is discovered.

Device configuration 52 participates in configuring computer peripheral devices within the network. Device configuration traffic is relayed from device configuration 52.

Legacy-polling device 54 participates in the polling for Legacy device events. With a Legacy device, data cannot be pushed to the client. Instead, the client has to poll the Legacy device for data. As an example, one event comprises a toner low signal.

Device event receive 56 participates in a device event push. With EWS, data can be pushed to a client without the client requesting the data. The client doesn't have to poll for data. Instead, the device can push the data.

Email alerts 64 are generated for: a maintainer; a consumable purchaser; an MIS manager; and a service provider. Web interface functionality is provided for: a maintainer; a consumable purchaser; an MIS manager; and a service provider.

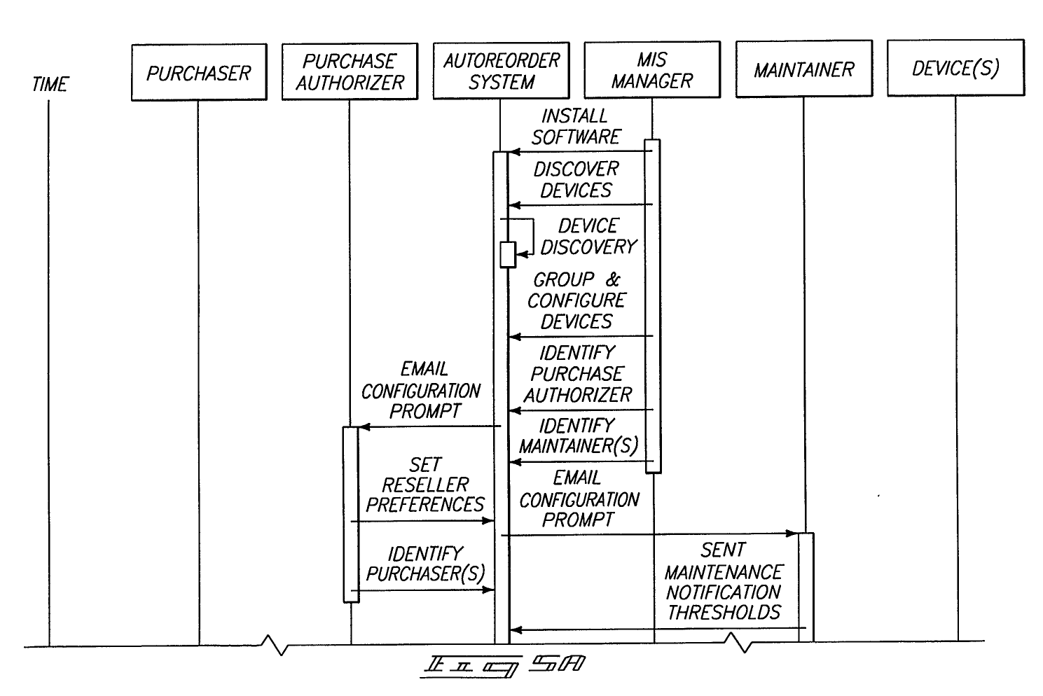

With reference to the flow diagrams of FIGS. 3-4, the following terminology is ascribed the following meaning.

The term “PML” refers to Printer Management Protocol, which is an object-oriented request-reply printer management protocol available from Hewlett-Packard Company, of Palo Alto, Calif. Further details of PML are located at http://www.hp.com. PML comprises a protocol that allows applications to exchange device management information with printers. PML is an object-oriented request-reply protocol which supports a synchronous printer query, control, and monitor capabilities. Details of PML are available at Applicant's developer website, http://www.hndevelopersolutions.com, by entering a user name, a user selected password, and by joining a solutions provider program including entering a personal profile. More particularly, a PML Protocol Specification, Hewlett-Packard Company, Nov. 18, 1998, Revision 2.3 is available therein, and is herein incorporated by reference.

Printer Management Language (PML) protocol is a protocol which permits many applications to exchange device management information with numerous computer peripheral devices, such as image forming devices. PML is an object-oriented request-reply protocol which supports asynchronous printer query, control, and monitor capabilities. Individual computer peripheral devices implement any conversion operations between the protocol used to exchange information with respect to computer peripheral devices (e.g., SNMP) and the internal protocol (e.g., PML) used within the respective computer peripheral devices.

One exemplary remote query language implemented within the network system is a Simple Network Management Protocol (SNMP). In such an exemplary configuration, host devices such as personal computers include respective processing circuitry (not shown) operable to formulate an appropriate SNMP query or request which is addressed to one or more appropriate computer peripheral devices using a communication medium. The appropriate computer peripheral device(s) receive the query or request and provide information back to appropriate host devices or PCs using the communication medium. Protocols other than SNMP are utilized in other embodiments to implement communications within the system.

More particularly, PML comprises a Hewlett-Packard version of IEEE Counsel Standard MIBs. A MIB, or Management Information Base, comprises an SNMP structure that describes the particular device being monitored. More particularly, a MIB comprises a data structure that defines what is obtainable from a device, as well as what can be controlled, such as what can be turned off, on, etc. Accordingly, there exist PML objects that correspond with MIB objects. SNMP, or Simple Network Management Protocol, comprises a widely-used network monitoring and control protocol. According to the protocol, data is passed from SNMP agents, which are hardware and/or software processes reporting activity in each network device (hub, router, bridge, etc.) to a workstation console that is used to oversee a network. The agents return information contained in a MIB.

The term “embedded web server” refers to a web server that is completely contained within a device, such as a computer peripheral device. Embedded web servers are configured to provide management information about the device. Accordingly, an “embedded web server” can be used with Applicant's invention to manage individual devices present on a centralized network. A web browser can be used by a network user to access an embedded web server in order to obtain network printer status updates, perform troubleshooting operations, change device configuration settings, and link to online customer support. For cases where it is necessary to manage many network devices, use of an integrated Web server management tool, such as HP Web JetAdmin, is more effective.

The term “web browser” refers to an application that runs on a workstation, or personal computer (PC) within a network environment, that lets users view HTML documents on the Web, access hyperlinks, and transfer files. In operation, web browsers request information from Web servers and display the information that the Web servers send back. The information is organized into Web pages, which contain text, graphics, sound, and animation formatted by HTML and Java applets. As an example, HP Web JetAdmin supports Netscape Navigator and Microsoft Internet Explorer.

The term “web server” refers to a specialized program running on a server that supports TCP/IP protocol. Web servers enable workstations, or personal computers (PCs), on a network to access the Web. Web servers receive HTTP requests that Web browsers running on client workstations send. The Web server could be asked to get a text or graphics file, retrieve a ZIP file, or run a program such as HP Web JetAdmin. The Web server then sends the information, files, or program results back to the requesting browser. Embedded Web servers are contained within HP JetDirect print servers and within the printer itself to provide management information about the device.

Also with reference to the flow diagrams in FIGS. 3-4, the following uniform notation has been utilized to identify “actors”, “objects”/“places”, “artifacts”, “actions”, and “workflows”. An ellipse is utilized to identify one or more “actors” having a common goal. A shaded rectangular box represents a single “object” or “place”. A rectangular box located along flow arrows indicates a physical or conceptual “artifact”. Additionally, “actions” are indicated along arrows. Furthermore, thin arrows indicate secondary “work flow”, whereas thick arrows indicate primary “work flow”, and dashed arrows indicate “possible work flow” (as used in FIG. 4).

As shown in FIG. 3, a manual process is shown for ordering consumables such as toner for one or more printers located within an office network environment. More particularly, the workflow interactions of an end user, a maintainer, and a purchaser, when they order toner and other supplies, are shown in a network environment such as an office.

FIG. 3 graphically depicts the interactions and needs for an end user, a maintainer, a purchaser, and a seller, reseller or other provider when manually ordering consumables for each of a plurality of printers in a common network environment pursuant to previously known techniques. More particularly, the interactions are shown between individuals and devices, as well as the information or workflow that transfers between actors and objects/places.

For purposes of this disclosure, a “maintainer” refers to an individual that is dedicated to maintaining operation of printers within a network environment.

From the perspective of a maintainer and with reference to FIG. 3, there are three possible ways that a “TONER LOW” condition can be delivered to the maintainer when a need to replenish toner is detected at one or more of the printers within the medium office network environment. First, the maintainer can visually detect a “TONER LOW” message that is displayed on a display of a printer. In response, the maintainer takes an action to provide “NEW TONER” to the printer. The maintainer can “GO TO INVENTORY” in order to retrieve a supply of new, replacement toner indicated by the action “NEW TONER”. The resulting new toner is then provided to the printer.

Secondly, the maintainer can “REQUEST PRINTER STATUS” at a PC dedicated for use by the maintainer. More particularly, this is carried out using device status utility 26. The “REQUEST PRINTER STATUS” is then made from the PC to the printer. In response, the printer sends a “TONER LOW MESSAGE” to the PC, and from the PC to the maintainer via a user interface of the PC.

Thirdly, the maintainer can be informed verbally, or externally of the network, by an end user that toner is low, which is indicated by the action “INFORM OF TONER LOW”. In response, the maintainer takes an action of “REQUEST NEW TONER” from a purchaser. The purchaser will either “CHECK INVENTORY” with an inventory of toner, after which “INVENTORY LEVEL” information is received from the inventory. If inventory level is sufficiently low to warrant the purchase of new toner, the purchaser takes action to “REQUEST TONER” from a reseller of toner by physically going to the reseller, or by using a facsimile, a telephone, mail, or email. In response, the purchaser receives “NEW TONER” from the reseller. Subsequently, the purchaser resupplies the purchased “NEW TONER” to the inventory.

From the perspective of an end user, there are two possible ways that a “TONER LOW” condition can be delivered to the end user when a need to replenish toner is detected at one or more of the printers within the medium office network environment. First, the end user can visually detect a “TONER LOW” message that is displayed on a display of a printer. In response, the end user takes an action to provide “NEW TONER” to the printer. The end user can “GO TO INVENTORY” in order to retrieve a supply of new, replacement toner indicated by the action “NEW TONER”. Optionally or additionally, the end user can “REQUEST NEW TONER” from a purchaser as described below in greater detail.

Secondly, the end user can take action to “OPEN A DEVICE STATUS UTILITY” at a PC, and take action to “REQUEST PRINTER STATUS”. In response, the printer sends a “TONER LOW MESSAGE” to the end user via the PC when the printer is low (or out) of toner, and it is determined that the toner needs to be replenished.

From the perspective of a purchaser, there are three possible ways that replacement toner can be obtained in order to satisfy a request for new toner. First, the purchaser can take action to “CHECK INVENTORY”, as previously discussed. Secondly, the purchaser can take action to “REQUEST TONER” from a reseller, as previously discussed. Thirdly, the purchaser can take action to “ORDER TONER” via a PC through the Internet. According to such option, the PC is used to “ORDER TONER” via the Internet from a reseller.

When the purchaser requests toner from the reseller, the purchaser can request toner by: going to a physical store location; by submitting a facsimile order, by submitting a telephone order with the reseller, or by sending a mail order or an e-mail order to the reseller.

As shown in FIG. 3, a reseller will periodically take action to “check inventory” at the inventory location. For example, the reseller can physically go to the inventory location such as by periodically visiting the inventory location to determine the availability of replacement toner therein. In response to checking the inventory, the reseller is able to determine the “inventory level”. When needed, the reseller can take action to provide “new toner” to the inventory location in response to receiving the “inventory level” at a level which requires replenishment.

FIG. 4 graphically depicts the interactions and needs for an end user, a maintainer, a purchaser, and a seller, reseller or other provider when ordering consumables for each of a plurality of printers in an office network environment using the consumable order assistance system of the invention. More particularly, interactions are shown between individuals and devices, along with the information or workflow that transfers between actors and objects/places.

According to FIG. 4, printers 14 and 14′ of FIG. 1 are provided within an office network environment. Printer 14 includes an embedded web server (EWS) 42. Server 48 comprises a centralized server including a consumable re-order program referred to as Peripheral Management System software.

From the perspective of a maintainer, there are two possible ways to retrieve a consolidated maintenance status for one or more of the printers within an office network environment. First, the maintainer takes action to “BROWSE TO PERIPHERAL MANAGEMENT SYSTEM AND REQUEST MAINTENANCE STATUS” via a PC. The PC then takes action to “REQUEST MAINTENANCE STATUS” from the centralized server that implements the Peripheral Management System. In response, the centralized server monitors the network via the Peripheral Management System to determine the status of each printer within the network, and to determine the status of supplies for each printer. More particularly, the centralized server can deliver a “PRINTER MAINTENANCE STATUS” to the PC via the network. Optionally, the centralized server can deliver a “CONSOLIDATED PRINTER E-MAIL” to the PC. Furthermore, the centralized server can deliver a “TONER LOW E-MAIL” to the PC. Accordingly, the centralized server with the Peripheral Management System is operative to consolidate the maintenance status of each printer, consolidate the status of supplies for each printer, and deliver toner low messages to the maintainer via the PC. Additionally, the PC can receive a “TONER LOW ALERT” from a printer with an electronic web server (EWS), as described below in greater detail.

The maintainer then receives a “CONSOLIDATED MAINTENANCE STATUS” from the PC in response to generation of the “CONSOLIDATED MAINTENANCE STATUS” from the centralized server. Additionally, the maintainer receives a “CONSOLIDATED PRINTER E-MAIL” from the PC in response to generation of such e-mail from the centralized server. Furthermore, the maintainer receives a “TONER LOW E-MAIL” from the PC in response to generation of such e-mail from the centralized server.

In response to receiving an indication that one or more printers need toner (or other supplies or components), the maintainer takes action to “GO TO INVENTORY” to locate a supply of toner at the inventory location. In response, “NEW TONER” is provided to the maintainer. As will be described below, “NEW TONER” is provided periodically to the inventory location from a reseller. Upon receiving “NEW TONER”, the maintainer provides the “NEW TONER” to the printer.

From the perspective of an end user, the end user takes action to submit a print job “PRINT” to a printer via a PC that includes a print driver and device status. The PC takes action, in response to the submitted print job, to “SEND A PRINT JOB” to the printer. In response, the printer takes action to send a “TONER LOW JOB ALERT” to the device status utility of the PC. The PC then displays to the end user via a user interface a “TONER LOW JOB ALERT”.

From the perspective of a purchaser, the purchaser can browse to the peripheral management system software on the centralized server via the PC using a web browser. In response to direction from the purchaser, the PC takes action to “REQUEST ORDER STATUS” from the centralized server. The centralized server, using the consumable re-order program (peripheral management system software), generates and sends a “CONSOLIDATED ORDER STATUS” notice to the PC in response to receiving the “REQUEST ORDER STATUS”. The PC then displays the “CONSOLIDATED ORDER STATUS” to the purchaser via a user interface of the PC.

Optionally or additionally, the PC takes action to generate and forward a “TONER ORDER MESSAGE” to the centralized server. The centralized server, using the consumable re-order program, generates and sends a “CONSOLIDATED TONER E-MAIL” to the PC. The PC then displays the “CONSOLIDATED TONER E-MAIL” to the purchaser via a user interface of the PC.

The centralized server, via the consumable re-order program, receives a “TONER LOW ALERT” from each printer within the network. The consumable re-order program automatically consolidates toner low conditions to generate and forward the “CONSOLIDATED TONER E-MAIL” to the PC.

As shown in FIG. 4, the purchaser can “CLICK ON A HOT-LINK” via a PC to a web site (via the Internet) that is configurable to work with an internal customer order system, or an external web site, to order replacement consumables such as toner. A “hot-link” comprises a URL (Uniform Resource Locator), or an address that defines a route to a file on the Web or any other Internet facility. In response, the Internet is used to “ORDER TONER” from a reseller. Upon receiving new toner from the reseller, the purchaser can stock the supply of “NEW TONER” at the inventory location.

Finally, the purchaser can take action to “CHECK INVENTORY” at the inventory location. In response, the inventory location will provide or indicate an “INVENTORY LEVEL” to the purchaser.

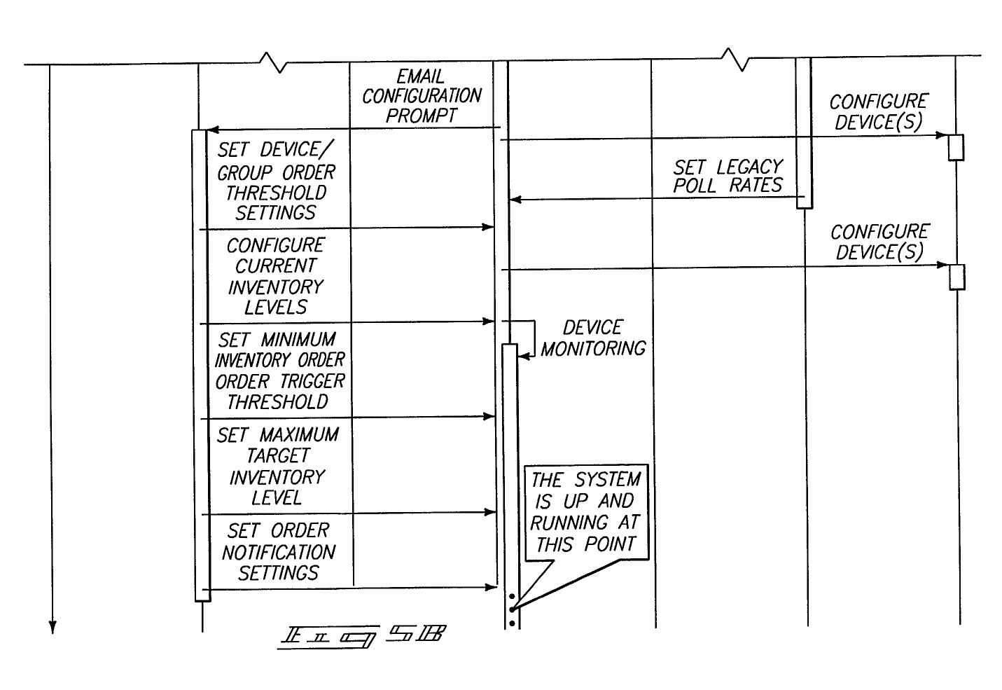

FIG. 5 is a sequence diagram showing setup interactions between individuals and devices in FIG. 4. More particularly, following a time line, an MIS manager installs software with the AutoReorder system upon installing one or more computer peripheral device(s). However, it is understood that variations in relative timing can occur between various interactions. Subsequently, the MIS manager discovers devices that are installed on the network by telling the AutoReorder system to find the devices. More particularly, the AutoReorder system does a broadcast to all devices, and the devices respond. Optionally or additionally, the AutoReorder system then automatically broadcasts to devices within the network to discover the devices.

The MIS manager groups and configures devices at the AutoReorder system for purposes of tracking the need for replenishing consumables and/or performing maintenance as a group. For example, devices within an engineering department could be grouped together. The MIS manager then identifies one or more purchase authorizers with the AutoReorder system.

Subsequently, the AutoReorder system sends an email configuration prompt to the one or more purchase authorizers, notifying them to configure their purchasing portion of the system. Next, the MIS manager identifies one or more maintainers within the network. Each purchase authorizer then sets reseller preferences at the AutoReorder system.

The AutoReorder system then sends an email configuration prompt to each of the one or more maintainers, notifying them to configure their maintenance portion of the system. Each purchase authorizer then identifies specific purchasers at the AutoReorder system. For example, a threshold can be set that tells a maintainer to change toner when only 10% of the originally supplied toner remains. Each maintainer then sets maintenance notification thresholds at the AutoReorder system. Next, the AutoReorder system sends an email configuration prompt to each of the purchasers. Subsequently, the AutoReorder system configures the one or more devices for the maintainer settings.

Next, the maintainer sets poll rates for Legacy devices that are present within the network. Each purchaser sets device and/or group threshold settings with the AutoReorder system. The AutoReorder system then configures each of the devices for the purchaser settings.

Each purchaser configures current inventory levels with the AutoReorder system. Subsequent to setting of the maintenance notification thresholds, the AutoReorder system continuously monitors the devices. Each purchaser then sets a minimum inventory order trigger threshold for an inventory supply with the AutoReorder system. The purchaser then sets a maximum target inventory level for an inventory supply with the AutoReorder system. Finally, the purchaser sets order notification settings for each inventory supply item with the AutoReorder system. From this point in time forward, the AutoReorder system is up and running.

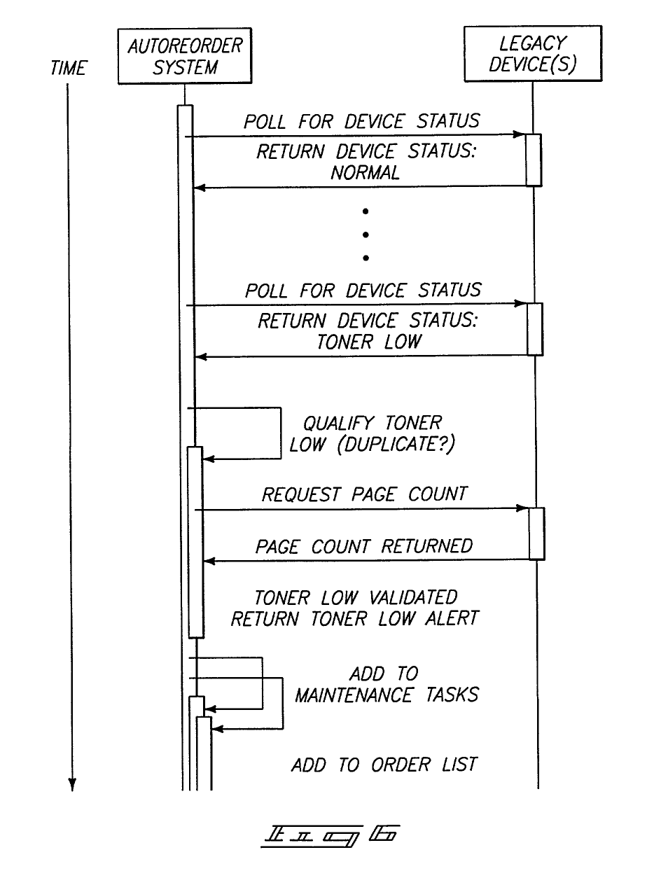

FIG. 6 is a sequence diagram illustrating interactions when polling Legacy devices. More particularly, following a time line, the AutoReorder system polls each Legacy device to obtain the status of each Legacy device. Each Legacy device then returns a device status indicating that the device is operating normally. Such polling and return of device status is repeated until a Legacy device returns a device status indicating that toner is low (or some other consumable needs replenishing, or the device needs maintenance).

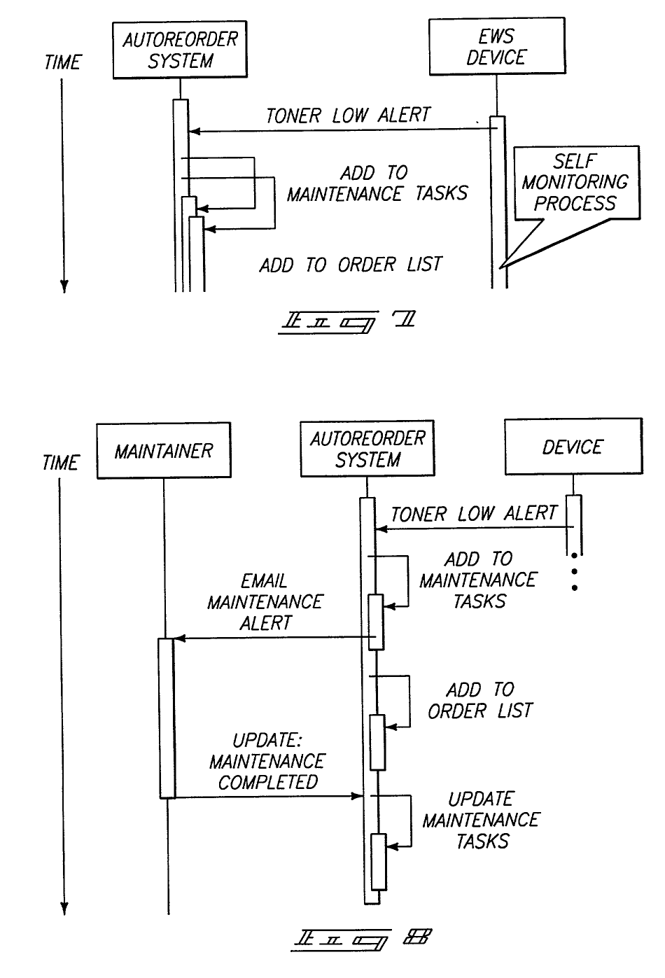

FIG. 7 is a sequence diagram illustrating interactions when an EWS-enabled device can do its own monitoring without a need for polling, and when generating a toner low alert from an embedded web server (EWS) based device. More particularly, following a time line, an electronic web server (EWS) device sends a toner low alert to the AutoReorder system. Subsequently, the AutoReorder system adds the toner low alert to a list of maintenance tasks. Also, the AutoReorder system adds the toner low alert to an order list for consumables that need to be ordered (or for maintenance that needs to be performed). Accordingly, a self-monitoring process is initiated for the EWS device using the AutoReorder system.

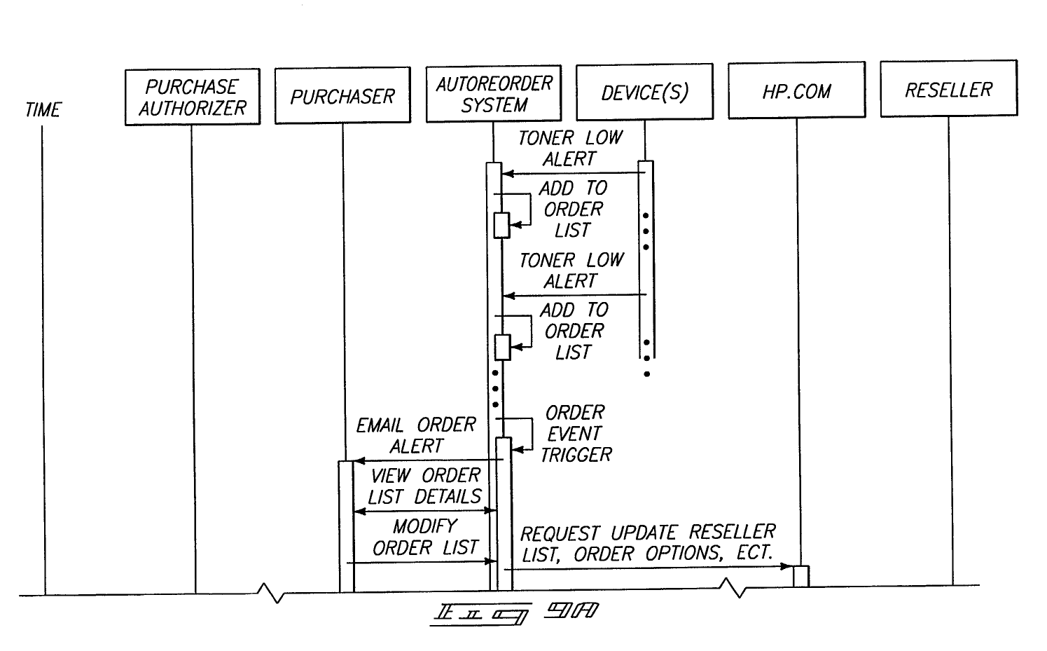

FIG. 8 is a sequence diagram illustrating interactions when sending an email maintenance alert to a maintainer via an AutoReorder System and a device that has generated a toner low alert. More particularly, following a time line, a device sends a toner low alert to the AutoReorder system (or a toner low condition is detected via polling). Subsequently, the AutoReorder system adds the toner low alert to a list of maintenance tasks. Next, the AutoReorder system sends an email maintenance alert to a maintainer. The AutoReorder system then adds the toner low alert to an order list for consumables. The maintainer then updates the AutoReorder system, thereby completing maintenance in response to the maintenance alert. The AutoReorder system then updates maintenance tasks internally of the AutoReorder system.

With reference to FIGS. 6, 8, and 9, it is assumed that the order level and the maintenance level are the same. However, as shown in FIG. 5, it is understood that they can be different.

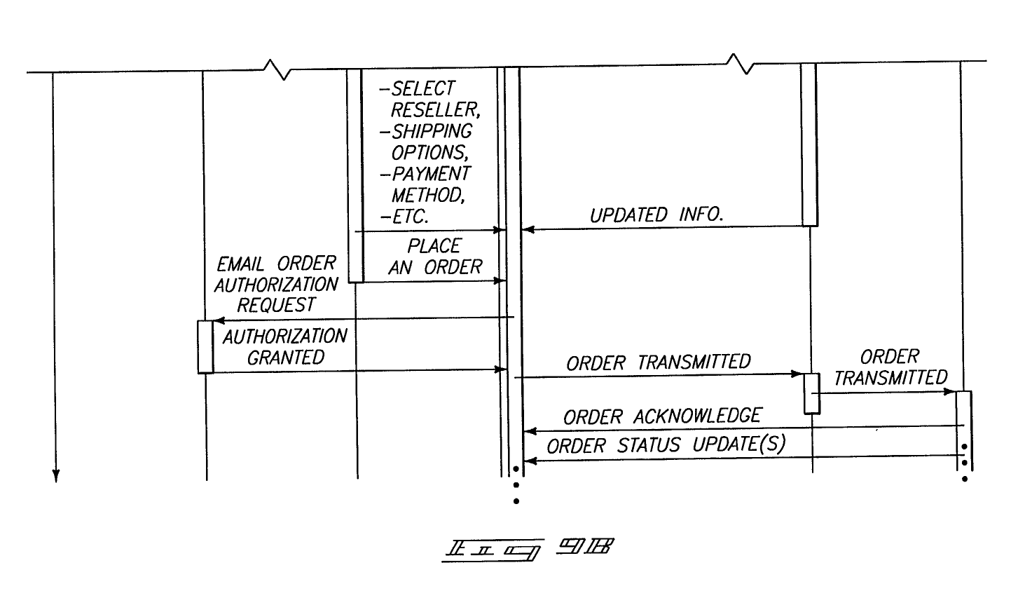

FIG. 9 is a sequence diagram illustrating ordering interactions between individuals and devices of FIG. 4. More particularly, following a time line, one or more devices send a toner low alert to the AutoReorder system. The AutoReorder system then adds the toner low alert to an order list. The same device (or another device) then sends another toner low alert to the AutoReorder system. The AutoReorder system then adds the subsequent toner low alert to the order list. For the case where the toner low alert comes from the same device, the second toner low alert might be for another color toner than for the first toner low alert, or for a different supply, or for a maintenance item (such as a fuser, a worn out photoconductor drum, or media).

Subsequent in time, the AutoReorder system generates an order event trigger that triggers ordering of each depleted (or soon to be depleted) toner (or other consumable). This process repeats from this point forward. The AutoReorder system then sends an email order alert to one or more purchasers, depending on which purchaser is responsible for ordering which consumable, or toner. Each purchaser (or individual with access to the AutoReorder system) can view details of the order list. Subsequently, the purchaser can modify the order list. An individual with access to the AutoReorder list (such as a purchaser or a maintainer) can request updated reseller lists, order options, and other details from a website maintained by a device manufacturer, such as www.hp.com, related to purchase transactions for consumable and/or maintenance. The device manufacturer website then sends update information to the AutoReorder system.

A purchaser then selects a reseller, shipping options, payment methods, and other transaction information at the AutoReorder system. Subsequently, the purchaser places an order via the AutoReorder system. The AutoReorder system then sends an email order authorization request to a purchase authorizer. Optionally, the AutoReorder system sends the email to the device manufacturer web site, and on to the reseller. The purchase authorizer then grants authorization to place the order. The AutoReorder system then transmits the order to the device manufacturer website. In response, the order is transmitted from the device manufacturer website to a selected reseller. The reseller then sends an order acknowledgment to the AutoReorder system, as well as one or more order status updates. Optionally, the order could be transmitted from a purchaser, a purchase authorizer, or the AutoReorder system directly to the reseller.

The automatic re-order and re-order assistance features, from the perspective of the maintainer, entail the intelligent configuration and notification of a maintainer when consumables and maintenance need to be replaced or replenished on one or more peripheral devices or printers. More particularly, the maintainer is notified when something needs to be replaced or replenished on the printers. This notification includes the provision of configurable threshold settings for specific items needing replenishment, such as levels of detected toner, which warrant replenishment of such toner. Additionally, warnings can be provided to the maintainer of other consumables present in the printer that are near a threshold level, and which might also warrant replenishment at the same time as another consumable which had been determined to immediately need replenishment. For example, for the case of a color printer it may be detected that cyan ink is low and requires immediate replenishment. However, it is beneficial to detect the condition of other ink colors that are sufficiently close to the threshold and which are more expeditiously replenished concurrently with cyan. For example, it may be determined that while cyan is low and requires replenishment, magenta is sufficiently low to require concurrent replenishment. Accordingly, replenishment of a plurality of consumables when each is sufficiently proximate a threshold level saves time and effort in conducting such replenishment.

Furthermore, the intelligent configuration and notification of a maintainer can entail notifying the maintainer of urgent events such as when toner is out, media is out, or when parts of a peripheral device are beyond their projected lifetime. For example, a laser printer may require replenishment of toner; a paper tray may be close to empty of paper or media, or a photoconductive drum may be beyond a projected lifetime, thereby requiring repair time or down time for the printer in order to replace the photoconductive drum. A maintainer can be notified of the occurrence of such urgent events by way of the AutoReorder Software, software that assists in ordering or carries out the order process. Furthermore, the maintainer can be warned of other consumables that are present in the printer that are near a threshold level, as discussed above. For example, when cyan is determined to be out, magenta may be low or near low, and it is more efficient to replace the cyan and magenta colors concurrently.

With respect to a consumables purchaser using the AutoReorder Software within an office environment, unconsolidated re-order notifications can be sent to a consumables purchaser in order to inform them of “what” to order and “where” to order the consumables. Furthermore, the AutoReorder Software can be used to provide assistance in placing an order through intelligent electronic links, as illustrated with reference to FIG. 4.

More particularly, consolidated re-order notifications can be sent through e-mail in the form of a list of consumables that need replacement. For example, a list of consumables might include a list of media or paper, toner cartridges, or ink reservoirs. The e-mail is configured to contain a hot-link (or URL) to a web site that is configurable to work with an internal customer ordering system. Alternatively, the e-mail contains a hot-link (or URL) to an external web site. An exemplary external web site could be a web site operated by Applicant, or a reseller web site that is approved by Applicant. Such a web site is configured to provide a customized list of “preferred” or “favorite” resellers, provide access to a complete reseller list of Applicant, and contain a preconfigured shopping cart. The shopping cart can include items that are needed, delivery addresses, attention notices provided by the purchaser, etc. Such an external web site may also contain information regarding new consumable products. For example, the web site might include information regarding a new high capacity toner cartridge which has recently been introduced into the marketplace.

Additionally, consolidated re-ordering notifications can encompass an external web site configured to send an e-mail after a consumables purchaser has placed an order. The external web site then provides order confirmation and information, such as providing a projected delivery date.

In another form, a consolidated re-order notification comprises hooks that are provided to allow a customer to customize where a re-order is sent, for the case of customers that have an internal, or proprietary, ordering system. The ordering system is further configured to implement part number translation wherein a customer part number is mapped, or assigned, to a manufacturer's part number for the consumable being ordered.

From the perspective of an administrator, when using the peripheral management software, general usage information can be provided for individual devices. Additionally, notification can be provided of “special” events, such as the presence of an extra-large print job, in the case of a printer. As one example of general usage information, a web status page can be displayed to an administrator in a form that summarizes usage for a particular printer over a period of time. This information can be re-set on a periodic basis by the administrator. Alternatively, the information can be re-set when the information is accessed by the administrator. As a further additional feature, for the case of toner usage, a brand of toner can be included in such information, thereby indicating the brand of toner that has been used previously so this information can be utilized when ordering new toner.

Accordingly, a consumable component replenishment and maintenance assistance system is provided for a centralized network environment. As was discussed above with reference to FIG. 4, one or more computer peripheral devices are provided within a network. Each computer peripheral device has a consumable component. In some cases, the computer peripheral device has an embedded web server. In other cases, the computer peripheral device does not have an embedded web server, and the computer peripheral device is polled for status. At least one personal computer is also provided within the network. The personal computer includes a user interface that is usable by a maintainer in one implementation in order to maintain operation of the at least one computer peripheral device. The server, preferably a centralized server, is provided within the network. The server has a consumable component consolidation program that is operative to monitor the at least one computer peripheral device in order to identify a need to replenish a consumable component and/or perform maintenance. The program also consolidates the identified need to replenish the consumable component or performs maintenance for one or more of the at least one computer peripheral devices in the network environment. Furthermore, the program notifies a maintainer of the consolidated, identified need by rendering instructions that are sent to the maintainer at the personal computer.

In one instance, the consumable component replenishment and maintenance assistance system further includes another personal computer and an electronic communication link that signal couples the another personal computer with an external seller of the consumable component for one of the at least one peripheral devices. However, it is possible for a single person to act as both a maintainer and a purchaser, wherein maintenance and purchasing occur from a common PC.

According to another implementation, the consumable component replenishment and maintenance assistance system further includes another personal computer. The another personal computer is operative to monitor the at least one computer peripheral device in order to determine the state of a consumable for each of the at least one computer peripheral devices. The another personal computer is further operative to notify a user via the user interface of a need to replenish one or more consumables.

According to yet another implementation, the consumable component replenishment and maintenance assistance system further includes another personal computer and another server, wherein the server is centralized, and having a consumable re-order program. The consumable re-order program includes instructions to send a consumable re-order notification to a consumables purchaser at the another personal computer.

According to even another implementation of the consumable component replenishment and maintenance assistance system, the consumable component comprises a first consumable component. Additionally, a second consumable component unique from the first consumable component is also provided. The consolidation program monitors the peripheral to identify when the second consumable component is near a threshold level requiring replenishment. In one case, the consolidation program generates a warning message indicating that the second consumable component is near a threshold level.

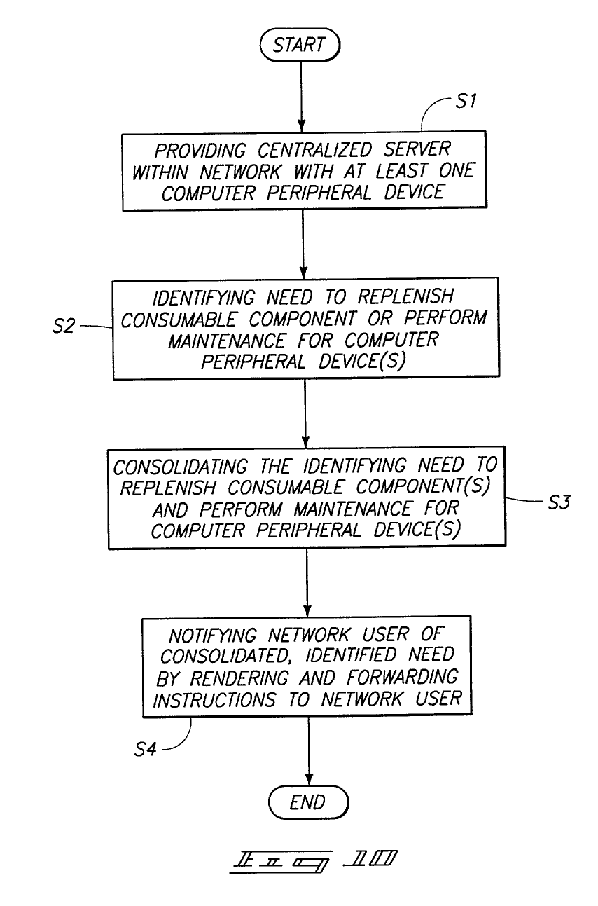

FIG. 10 forms a process flow diagram showing the logic processing for replenishing consumable components within at least one computer peripheral device of a centralized network. More particularly, FIG. 10 illustrates the logic processing used to replenish consumable components according to Applicant's invention.

In Step “S1”, a centralized server is provided within a network communicating with the at least one computer peripheral device. After performing Step “S1”, the process proceeds to Step “S2”.

In Step “S2”, the process proceeds by identifying a need to replenish a consumable component or to perform maintenance for each of the at least one peripheral components. After performing Step “S2”, the process proceeds to Step “S3”.

In Step “S3”, the process proceeds with consolidating the identified need to replenish the consumable component and perform maintenance for one or more of the at least one computer peripheral device in the network. After performing Step “S3”, the process proceeds to Step “S4”.

In Step “S4”, the process proceeds to notifying a network user of the consolidated, identified need by rendering and forwarding instructions to the network user. After performing “S4”, the process is periodically resumed or terminated.

In one instance, the network user is a maintainer interacting with the network at a personal computer. In another instance, the network user is an end user interacting with the network at a personal computer having a print center. In yet another instance, the network user is a purchaser of consumables that is interacting with the network at a personal computer. In a further instance, identifying comprises comparing a state of a consumable component with a predefined state, and when the compared identified state corresponds with the predefined state, generating an order request for the consumable for submission to a seller of the consumable via a communication link. In one case, the communication link comprises the Internet.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

What is claimed is:

1. A consumable component replenishment and maintenance assistance system for a centralized network environment, comprising:
a computer network;
at least one computer peripheral device within the network and having a consumable component;
a personal computer within the network and having a user interface usable by a maintainer to maintain operation of the at least one computer peripheral device; and
a server within the network and having a consumable component consolidation program operative to monitor the at least one computer peripheral device to identify a need to replenish a consumable component and/or perform maintenance, and to notify a maintainer of the identified need by rendering instructions that are sent to the maintainer at the personal computer.

2. The system of claim 1 wherein the consumable component consolidation program is further operative to consolidate the identified need to replenish the consumable component and/or perform maintenance for one or more of the at least one computer peripheral device in the network environment.

3. The system of claim 1 further comprising another personal computer and an electronic communication link signal coupling the another personal computer with an external seller of a consumable component for one of the at least one peripheral devices.

4. The system of claim 1 further comprising another personal computer, wherein the another personal computer is operative to monitor the at least one computer peripheral device to determine the state of a consumable for each of the at least one computer peripheral devices, and notify a user via the user interface of a need to replenish one or more consumables.

5. The system of claim 1 further comprising another personal computer and another centralized server having a consumable re-order program including instructions to send a consumable re-order notification to a consumables purchaser at the another personal computer.

6. The system of claim 1 wherein the consumable component comprises a first consumable component, and further comprising a second consumable component unique from the first consumable component, wherein the consolidation program monitors the at least one computer peripheral device to identify when the second consumable component is near a threshold level requiring replenishment and/or maintenance and the consolidation program consolidates the need to replenish and/or perform maintenance on the first and second consumable components.

7. The system of claim 6 wherein the first consumable component resides on a first peripheral device, and the second consumable component resides on a second peripheral device.

8. The system of claim 6 wherein the first consumable component and the second consumable component reside on a common peripheral device.

9. The system of claim 6 wherein the server is operative to automatically notify a maintainer of the consolidated need to replenish and/or perform maintenance.

10. The system of claim 6 wherein the server is operative to automatically notify a purchaser of the consolidated need to replenish and/or perform maintenance.

11. The system of claim 6 wherein the consolidation program generates a warning message indicating that the second consumable component is near the threshold level.

12. The system of claim 1 wherein the centralized server comprises an integrated web server operative to manage network peripheral devices.

13. The system of claim 1 wherein the consolidation program includes a configurable threshold setting for the consumable component of the peripheral device, wherein a user of the centralized server selectively configures the threshold setting for the consumable component such that the identified need to replenish the consumable component is triggered by the threshold setting.

14. A consumable order assistance system for a computer peripheral device within a centralized network environment, comprising:
a personal computer having a user interface;
a computer peripheral device including a consumable;
a centralized server having a consumable re-order program including instructions to send a consumable re-order notification to a consumables purchaser at the personal computer; and
a computer network interconnecting the personal computer, the computer peripheral device, and the centralized server.

15. The consumable order assistance system of claim 14 further comprising an electronic communication link signal coupling the personal computer with a provider of the consumable for the peripheral device.

16. The consumable order assistance system of claim 14 wherein the centralized server includes a consumable component consolidation program for monitoring the at least one computer peripheral device to identify a need to replenish a consumable component and/or perform maintenance, consolidating the identified need to replenish the consumable component and/or perform maintenance for one or more of the at least one computer peripheral device in the network environment, and notifying a user of the consolidated, identified need by rendering instructions that are sent to the user at the personal computer.

17. The consumable order assistance system of claim 15 wherein the consumable re-order program automatically initiates an order for consumables in response to identifying a need to replenish a consumable component.

18. The consumable order assistance system of claim 14 wherein the electronic communication link comprises an e-mail system within the network environment, wherein a list of consumables that need replacement are sent to the personal computer via an e-mail message from the centralized server.

19. The consumable order assistance system of claim 18 wherein the e-mail message includes a hot link to a web site of consumable reseller information.

20. The consumable order assistance system of claim 19 wherein the hot link is to a web site that is configured to work with an internal customer order system.

21. The consumable order assistance system of claim 19 wherein the hot link is to a web site that is configured to work with an external web site including a list of providers of the consumable.

22. The consumable order assistance system of claim 18 wherein the e-mail system facilitates consumable ordering by a purchaser at the personal computer.

23. A computer-implemented system which implements a program in which consumable components of computer peripheral devices in a centralized network system are replenished, the system comprising:
a monitoring system which identifies a need to replenish one or more consumable components and/or perform maintenance for any one of a plurality of unique computer peripheral devices within the network system;
a notification system which notifies a user of the identified need to replenish components and/or perform maintenance; and
a consumable order placement system which generates an order with a supplier of consumables in response to a user authorizing the order.

24. The computer-implemented system of claim 23 wherein the monitoring system comprises a server, a peripheral device having one or more consumable components, and a bi-directional communication link, wherein the server polls or sets up the peripheral device to perform an internal check and notifies the server when a need is determined to replenish one or more consumable components and/or perform maintenance.

25. The computer-implemented system of claim 23 wherein the notification system comprises a server, at least one client PC, and a communication link provided between the server and the at least one client PC, wherein the server generates and forwards a notification to a user at one of the at least one client PC.

26. The computer-implemented system of claim 23 wherein the consumable order placement system is resident on a central server within a network environment having a plurality of PCs.

27. The computer-implemented system of claim 23 wherein the consumable order placement system is resident on a PC within a network environment having a central server.

28. The computer-implemented system of claim 23 further comprising a consumable consolidation program for monitoring the at least one computer peripheral device to identify any need to replenish consumable and/or perform maintenance, consolidating the identified need to replenish consumables and/or perform maintenance for one or more of the at least one computer peripheral device in the network environment, and notifying a maintainer of the consolidated, identified need by rendering instructions that are sent to the maintainer at the personal computer.

29. The computer-implemented system of claim 28 wherein the consumable consolidation program notifies the maintainer of the consolidated, identified need by generating and forwarding an email to the maintainer that indicates the consolidated, identified need.

30. The computer-implemented system of claim 29 wherein the email comprises a notification that a printer needs replenishment of at least one consumable and/or maintenance.

31. The computer-implemented system of claim 29 wherein the email comprises a notification in the form of an itemized list that a plurality of computer peripheral devices each needs replenishment of at least one consumable and/or maintenance.

32. The computer-implemented system of claim 29 wherein the consumable consolidation program notifies the maintainer of the consolidated, identified need for a single computer peripheral device by consolidating the need for a plurality of unique consumable components and notifying the maintainer of the consolidated need for the single computer peripheral device.

33. The computer-implemented system of claim 23 wherein the monitoring system comprises a centralized server communicating with the at least one computer peripheral device and further operative to consolidate the identified need to replenish one or more consumable components and/or perform maintenance for one or more of the computer peripheral devices.

34. The computer-implemented system of claim 23 wherein the notification system comprises an embedded web server within a computer peripheral device and a centralized server communicating with the computer peripheral device.

35. The computer-implemented system of claim 23 wherein the notification system comprises a Legacy computer peripheral device and a centralized server provided within the network, wherein the centralized server periodically polls the Legacy device to obtain a status of the Legacy device relating to status of a consumable component and/or a need to perform maintenance on the Legacy device.

36. The computer-implemented system of claim 23 wherein the consumable order placement system comprises a centralized server provided within the network and communicating with a provider of consumables via the Internet.

37. A method for replenishing consumable components of at least one computer peripheral device within a centralized network, comprising:
providing a centralized server within the network communicating with the at least one computer peripheral device;
identifying a need to replenish a consumable component and/or perform maintenance for each of the at least one computer peripheral components; and
consolidating the identified need to replenish the consumable component or perform maintenance for one or more of the at least one computer peripheral device in the network.

38. The method of claim 37 further comprising notifying a network user of the consolidated, identified need by rendering and forwarding instructions to the network user.

39. The method of claim 37 wherein the network user is a maintainer interacting with the network at a personal computer.

40. The method of claim 37 wherein the network user is an end user interacting with the network at a personal computer having a device status interface.

41. The method of claim 37 wherein the network user is a purchaser of consumables interacting with the network at a personal computer.

42. The method of claim 37 wherein identifying comprises comparing a state of a consumable component with a predefined state, and when the compared identified state corresponds with the predefined state, generating an order request for the consumable for submission to a provider of the consumable via a communication link.

43. The method of claim 42 wherein the communication link comprises the Internet.

44. The method of claim 37 wherein identifying a need comprises receiving a warning notification from a computer peripheral device that the computer peripheral device is down or is about to go down.
